(19) United States
(12) Patent Application Publication
(10) Pub. No.: US 2026/0359224 A1
(43) Pub. Date: Nov. 12, 2026

(54) CACHE COHERENCY AND ADDRESS LOOKUPS

(71) Applicant: Arm Limited, Cambridge (GB)

(72) Inventors: Andrew David Tune, Dronfield (GB); Bijoy Pazhanimala, Bangalore (IN); Sean James Salisbury, Dendron (GB); Edward Martin McCombs, JR., Austin, TX (US)

(21) Appl. No.: 19/205,104

(22) Filed: May 12, 2025

(51) Int. Cl. G06F 12/0817; G06F 12/0831; G06F 12/084; G06F 12/0846

(52) U.S. Cl. CPC G06F 12/0828; G06F 12/0831; G06F 12/084; G06F 12/0846

(57) ABSTRACT

An apparatus includes: a coherence control circuit for managing coherency of a plurality of local memories, the coherence control circuit including: a preamble coherence memory; and a prologue coherence memory, wherein the preamble coherence memory stores at least one bit associated with an address tag of data stored at one or more of the plurality of local memories; and wherein the prologue coherence memory stores at least a portion of the address tag of data stored at the one or more of the plurality of local memories, wherein access to the prologue coherence memory is based on a partial hit of a received address on the at least one bit stored in the preamble coherence memory.

### BACKGROUND

In certain computing systems, data may be shared by several caches. For example, data processing systems, such as a System-on-a-Chip (SoC), may contain multiple processor cores, multiple data caches, and shared data resources. In a shared memory system for example, each of the processor cores may read and write to a single shared address space. Thus, when a processor (e.g., processor core of a SoC) modifies a value of data that is shared by several caches, the change needs to be propagated to all the caches storing a copy of the data.

Cache coherency is an issue in any system that contains one or more caches and more than one device sharing data in a single cached area. There are a number of potential problems with a system that contains caches. One potential problem is that memory may be updated (by another device) after a cached device has taken a copy. At this point, the data within the cache is out-of-date or invalid and no longer contains the most up-to-date data. Another potential problem is that systems that contain write-back caches must deal with the case where the device writes to the local cached copy at which point the memory no longer contains the most up-to-date data. A second device reading memory will see out-of-date (stale) data.

To assist with maintaining cache coherency (e.g., consistency and synchronization of data) across the several caches, a component is included in the computing system that monitors (“snoops”) the data on an interconnect. In a number of different computing systems, snoop filters are used to monitor data transactions and ensure cache coherency.

### BRIEF SUMMARY

Cache coherency and address lookups are described. As part of the described cache coherency control, energy consumption of allocation operations can be reduced through a tag way halting strategy involving storing a tag in two parts, where a first part of the tag is stored as part of a preamble coherence memory and a second part of the tag is stored as part of a prologue coherence memory. Access to the prologue coherence memory is based on a partial hit of a received address on the first part of the tag stored in the preamble coherence memory. The first part of the tag includes at least one bit associated with an address tag of data. The at least one bit can be a single bit of the address tag. In some cases, the first part of the tag includes an aggregate valid bit, which indicates presence of a cacheline/data at a memory address.

Advantageously, an empty way for allocating a new address can be identified by only checking the preamble coherence memory for a value of the aggregate valid bit without needing to check presence indicators that may be stored at the prologue coherence memory. In certain embodiments, the preamble coherence memory and the prologue coherence memory are part of a snoop filter memory.

In some aspects, an apparatus includes: a coherence control circuit for managing coherency of a plurality of local memories, the coherence control circuit including: a preamble coherence memory; and a prologue coherence memory, wherein the preamble coherence memory stores at least one bit associated with an address tag of data stored at one or more of the plurality of local memories; and wherein the prologue coherence memory stores at least a portion of the address tag of data stored at the one or more of the plurality of local memories, wherein access to the coherence memory is based on a partial hit of a received address on the at least one bit stored in the preamble coherence memory.

In some aspects, a method includes: detecting, by a coherence control circuit, an address of a memory location, wherein each local memory of a plurality of local memories provide a possible location of a copy of data from the memory location, wherein the coherence control circuit includes a preamble coherence memory and a prologue coherence memory, wherein the preamble coherence memory stores an aggregate valid bit; and wherein the prologue coherence memory stores at least a portion of an address tag of data stored at the one or more of the plurality of local memories; determining, by the coherence control circuit, that the address is not stored at any of the plurality of local memories; and identifying, by the coherence control circuit, an empty way for storing a new entry for the address at the coherence control circuit from the aggregate valid bit stored at the preamble coherence memory.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 is a block diagram of an apparatus such as a data processing system in which a way halting cache coherency control as described herein can be used.

FIG. 2A and FIG. 2B illustrate examples of snoop filter entries with an aggregate valid bit.

FIG. 3A illustrates an example entry of a preamble coherence memory of a coherence control circuit.

FIG. 3B illustrates an example entry of a prologue coherence memory of a coherence control circuit.

FIG. 4 illustrates an example operation of a coherence control circuit in accordance with certain embodiments described herein.

FIG. 5 illustrates an example coherence control circuit.

FIG. 6 is a block diagram of an example implementation of data processing system of FIG. 1.

FIG. 7 illustrates an example coherence preamble and prologue coherence memory that can be used as part of a coherence control circuit.

### DETAILED DESCRIPTION

Cache coherency and address lookups are described. As part of the described cache coherency control, energy consumption of allocation operations can be reduced through a tag way halting strategy involving storing a tag in two parts, where a first part of the tag is stored as part of a preamble coherence memory and a second part of the tag is stored as part of a prologue coherence memory. Access to the prologue coherence memory is based on a partial hit of a received address on the first part of the tag stored in the preamble coherence memory. The first part of the tag includes at least one bit associated with an address tag of data and may be a single bit.

Memory can be set-associative and organized by index and way. A cacheline refers to the data corresponding to a memory address. A set refers to a limited number of places in the memory where a cacheline can reside (e.g., if associativity is equal to 1, the memory is considered to be “direct mapped”). Each associativity corresponds to a “way.” For example, an associativity of 2 corresponds to two ways, an associativity of 4 corresponds to four ways, and an associativity of 16 corresponds to 16 ways. The index indicates which set a cacheline is stored or is to be stored into and is computed from the address. A tag refers to part of the address that is stored in the tag RAM and identifies, in conjunction with the index, the memory address that the cacheline corresponds with.

In certain implementations, the first part of the tag (stored in the preamble coherence memory) at least includes an aggregate valid bit, which indicates presence of a cacheline/data at a memory address. The aggregate valid bit can be an additional bit associated with an address tag of data and provides redundancy with respect to presence bits that may be stored in prologue memory.

Most modern system on chips (SoCs) are built with multiple processing cores. The shared memory programming paradigm makes it necessary for these multiprocessors to employ cache coherence protocols to maintain coherence between the many different caches in the system. Snoop protocols broadcast snoop messages to all caches to locate the copies on-demand. When a cache receives one of these snoop messages, the cache performs a tag array lookup to determine whether that cache has a copy of the requested block and sends a reply accordingly.

Most tag lookups performed because of snoop requests would fail to find copies of the requested block (miss). Consequently, snoop filters are employed to reduce energy consumption and improve scalability.

Snoop filters are commonly implemented as set-associative (including skewed-associative) tag arrays. Each coherent request queries the snoop filter by querying the tag array(s). This incurs an energy cost, but less than that of sending the snoop request across an on-chip network to one or more processing elements (such as a central processing unit (CPU) or a CPU cluster), which in turn may perform a cache tag lookup and maybe another lookup in a hierarchical snoop filter, as well as costing power in the network and processing element itself, especially if that processing element had to be woken from a low power state.

In some cases, such as for implementations using a large physical address space that require wide tags, or implementations having a large list of potential sharers to maintain in the snoop filter, or certain implementations with a sectorized snoop filter, each access to the snoop filter can incur a significant amount of energy. By utilizing a tag way halting strategy involving storing the tag in two parts, it is possible to reduce the energy consumption of each snoop filter tag access. As further described herein, various energy saving optimizations are possible through what is stored in the preamble coherency memory and the prologue coherency memory of a coherency control circuit such as a snoop filter, as well as by the memory configuration itself.

For example, cache coherency mechanisms, including snoop filters, store presence information on which region or block of cache is sharing a cacheline. By using “presence” (e.g., based on a vector or matrix of presence bits), there is no need to store an extra valid bit indicating that the tag itself is valid because the validity of the tag can be inferred from the existence of at least one presence (e.g., the OR of the presence vector or matrix). As presented herein, a single bit may be used to represent the OR of the presence vector or matrix of presence bits and this single bit can be referred to as an aggregate valid bit. The aggregate valid bit that corresponds to the presence of a cacheline/data at a memory address can support the performance functionality of a valid bit.

Advantageously, an empty way for allocating a new address can be identified by only checking the preamble coherence memory for a value of the aggregate valid bit. In certain embodiments, the preamble coherence memory and the prologue coherence memory are part of a snoop filter memory.

A typical inclusive snoop filter architecture is designed with lower associativity but higher capacity than the coherent caches it monitors. In this manner, there is a high probability that a free entry can be found in any set in which to store a record of a new cacheline allocation into one of the monitored caches. It is convenient to be able to find such an empty way at the same time as checking the snoop filter for a match in order to avoid the power consumption of a second lookup to determine a free/available way.

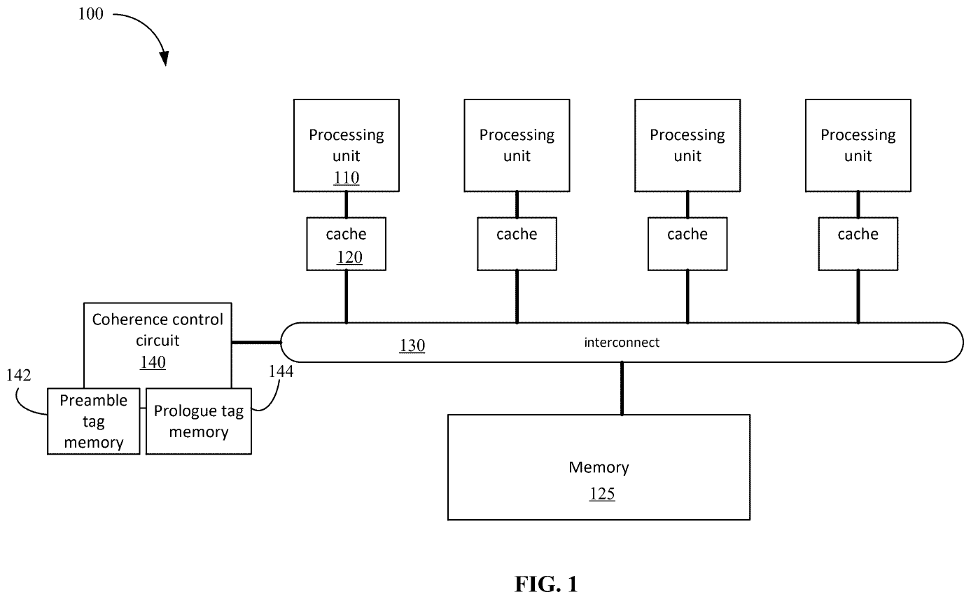

FIG. 1 is a block diagram of an apparatus such as a data processing system in which cache coherency and address lookup as described herein can be used. Data processing systems, such as a System-on-a-Chip (SoC), may contain multiple processing devices, multiple data caches and shared data resources (both on and off chip). Referring to FIG. 1, data processing system 100, includes a plurality of processing units 110, at least one local memory (e.g., cache 120 or other memory subsystem) for each processing unit 110, a shared memory 125, and an interconnect 130. Each local memory provides a possible location of a copy of data from the shared memory.

To assist with maintaining coherency of the local cache(s) 120 and shared memory 125, a coherence control circuit 140 having a preamble coherence memory 142 and a prologue coherence memory 144 is included.

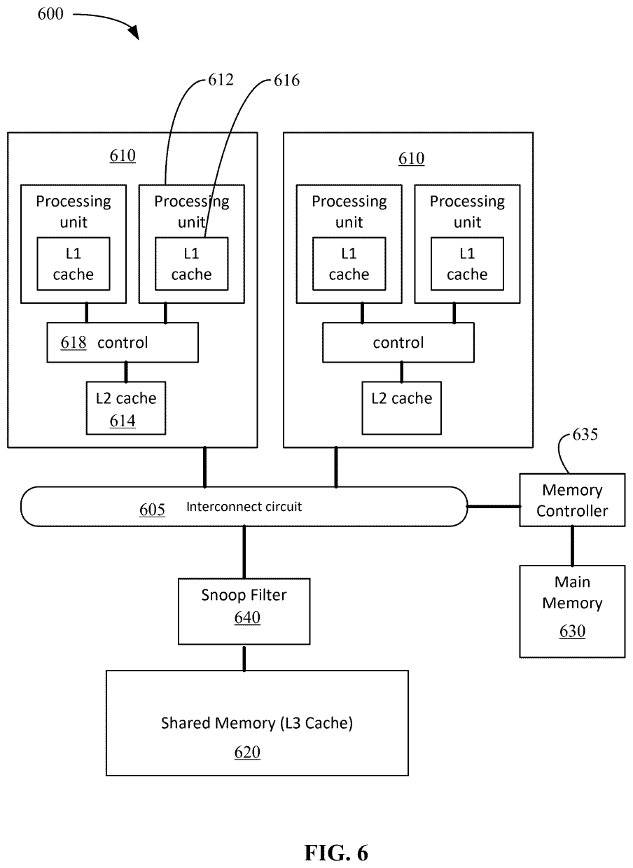

In some cases, the shared memory 125 includes a plurality of off-chip memory such as DRAM. In some cases, the shared memory 125 is a system-level cache (SLC), with the coherence control circuit between the interconnect 130 and the shared memory 125 (see e.g., FIG. 6). It should be understood that the described coherence control circuit 140 can be part of an apparatus that does not include a shared memory. The described coherence control circuit 140 can be provided as part of an apparatus with a plurality of local memories, where each local memory of the plurality of local memories provides a possible location of a copy of data and where the coherence control circuit 140 manages the coherency of the plurality of local memories.

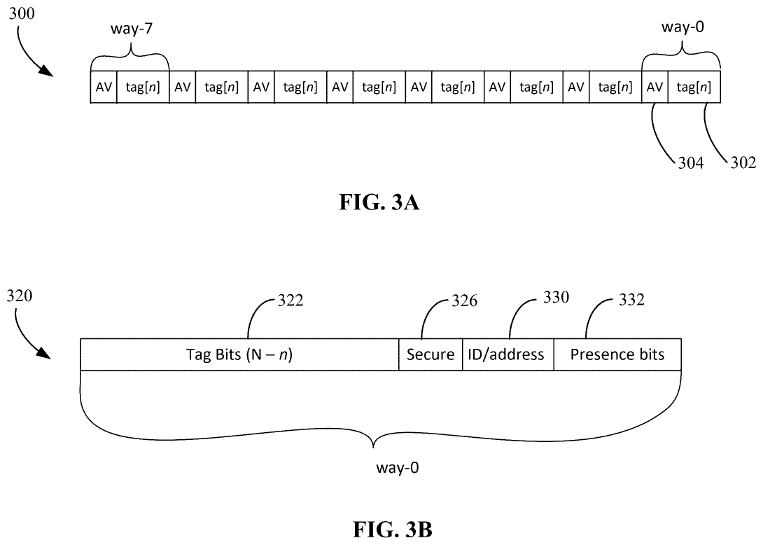

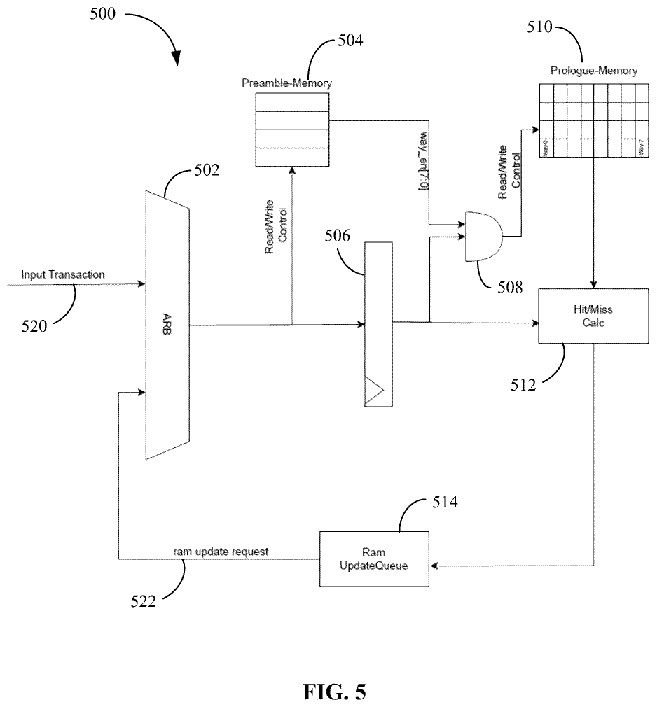

The preamble coherence memory 142 stores a first part (e.g., one or more bits) of a coherence control circuit entry for an address tag of data stored at one or more of the plurality of local memories (e.g., local caches 120) and the prologue coherence memory 144 stores a second part of the coherence control circuit entry (see e.g., example of a snoop filter entry below and examples shown in FIGS. 3A and 3B). An example implementation of coherence control circuit 140 is shown in FIG. 5. In some cases, coherence control circuit 140 provides a snoop filter. In addition to snoop filters, the described coherence control circuit 140 can be applicable to any structure that is set-associative including a cuckoo filter or other approximate/probabilistic data structure.

A coherence control circuit 140 manages the coherency of the local memories by keeping track of the coherency states of cache blocks and determines whether or not a particular cache controller (e.g., for cache 120) needs to check its cache tag. This reduces the power consumption caused by cache controllers performing lookups of their tags as only the cache controllers of the caches that hit a tag in the snoop filter are operated. It is also contemplated that a hierarchy of coherence control circuits 140 can be provided, with a coherence control circuit 140 (e.g., as a snoop filter) associated with a cluster of processing units with their own caches and a shared cluster cache.

To perform a lookup at the coherence control circuit 140, an address tag of an address detected on a bus or cacheline (e.g., on interconnect 130) is used to determine whether there is a hit with one of the address tags stored in a memory associated with the coherence control circuit 140.

As described in detail herein, a way halting approach can be carried out where instead of the full address tags being stored for each way, a first portion of an entry for an address tag is stored in a first memory, referred to as a “preamble” coherence memory, and a second portion of the entry for the address tag is stored in a second memory, referred to as “prologue” coherence memory. In this manner, certain operations can be carried out before completing a lookup operation of the address tag and coherency activities, thereby reducing power consumption and, in some cases, improving performance.

As mentioned above, in certain embodiments, the coherence control circuit 140 can provide a snoop filter. The snoop filter may be set-associative and sectorized. In some cases, the snoop filter is itself in the form of a snoop directory organized in sets and ways. A typical inclusive snoop filter architecture is designed with lower associativity but higher capacity than the coherent caches it monitors, such that there is a high probability that a free entry can be found in any set in which to store a record of a new cacheline allocation into one of the monitored caches. It is convenient to be able to find such an empty way at the same time as checking the snoop filter for a match in order to avoid the power consumption of a second lookup to determine a free way.

An example of information stored in a snoop directory is as follows:

| | | |
|---|---|---|
| Index | Tag + other information | Presence/Sharers (n bits) |

0
1
2
. . .

As shown in the example above, each entry of a typical inclusive snoop filter may contain an address tag and a vector of “presence” bits that indicate which coherent clusters need to be checked for the cacheline. For example, each processing unit can be represented as a bit in the n-bit vector such that a four-bit vector is used for representing four processing units (CPUs), where each bit position corresponds to a particular CPU and reflects whether that CPU is storing the address. In some cases, a matrix of presence bits may be provided (e.g., presence bits×sectors). The snoop filter may also contain some further coherency state information. In some cases, instead of a vector of presence bits, a list of pointers to the addresses of shares may be used. A list of pointers may be efficient in systems that have a high number of CPUs using a shared memory space. In some cases, a snoop filter entry can further include secure state bit(s) as well as some error correction code (ECC) bits.

In operation, when a CPU/local cache for the CPU evicts a cacheline, a message is sent to the snoop filter. The snoop filter performs a lookup. Since the address/cacheline is at the snoop filter, the lookup results in a hit and the vector bit corresponding to that CPU/local cache is cleared. If the address/cacheline is present at another CPU, that would be reflected in the corresponding presence bit and the address/cacheline remains present in the snoop filter.

In the snoop filter, when adding a new entry, the lookup checks for a hit and, if so, the existing snoop filter entry is updated. However, if there is no hit, it is desirable to find an empty way in a set on the first lookup in the snoop filter.

As described herein, a new bit is provided for inclusion in an entry of a cache coherence memory such as a snoop filter memory. This new bit can be referred to as an aggregate valid bit, which represents the bitwise OR of the presence bits/vector(s) or otherwise some indication of a list of sharers being not empty.

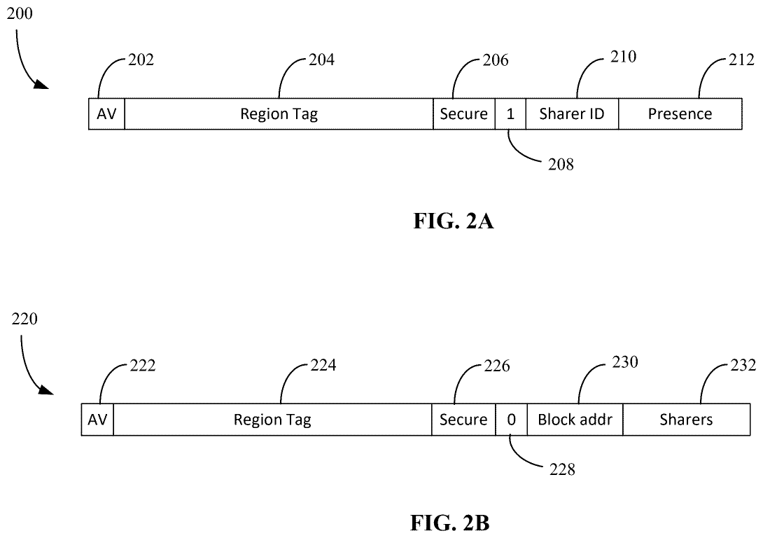

FIG. 2A and FIG. 2B illustrate examples of snoop filter entries with an aggregate valid bit. Referring to FIG. 2A, an entry 200 of a region entry type (e.g., sectorized configuration) can include an aggregate valid bit 202 (based on the presence vector), a region tag 204, secure state 206, entry type 208 (where 1=region), sharer identifier 210, and presence bits 212. The presence bits/vector 212 corresponds to a per-cacheline presence for each in the region for the shared cache or cluster with the same recorded sharer identifier 210. If the presence vector 212 is empty, the entry is invalid. Referring to FIG. 2B, an entry 220 of a block entry type can include an aggregate valid bit 222 (based on the sharers vector), a region tag 224, secure state 226, entry type 228 (where 0=cacheline), block address 230 (which is the address of the single cacheline within the region), and sharers bits 232. The sharers bits/vector 232 is a vector (or list) of caches sharing the cacheline. If the sharers vector 232 is empty, the entry is invalid.

In some cases, a way halting strategy can be applied and a portion of a snoop filter entry (e.g., portion of entry 200 or entry 220) can be stored in a preamble coherence memory and the remaining portion of the snoop filter entry (e.g., remaining portion of entry 200 or entry 220) can be stored in a prologue coherence memory. The optimum number of bits in the preamble coherence memory depends on the overall size of the snoop filter entry, the associativity, and on the precise semantics of the state stored, as some examples.

The way halting strategy with a lookup in a preamble coherence memory can assist with identifying a miss when the preamble coherence memory stores information having sufficient entropy. Sufficient entropy can be considered to occur when there is a reduced probability of a hit as compared to not utilizing the described way halting strategy.

The presence bits can be used to indicate whether or not an address is actually allocated at the local caches. However, it is not desirable to put all of the presence bits in the preamble coherence memory because the number of bits can adversely impact power consumption. In addition, in certain implementations, it may not be possible to fit all of the presence bits at the preamble coherence memory such as a case for when the snoop filter is sectorized. Therefore, a new bit, the aggregate valid bit, is created for storing as part of a preamble coherence memory that represents the information of the presence bits. The aggregate valid bit of a particular cacheline is evaluated each time an entry is inserted and is evaluated when an entry is deleted. The aggregate valid bit can be evaluated for a particular cacheline by performing an OR operation with the presence bits for that cacheline. During a deletion operation, upon the result of the OR operation indicating that the cacheline is not present at any of the CPUs, the aggregate valid bit can be updated to a value indicating invalid data/no presence (e.g., a logical 0 can be written).

Accordingly, in some cases, only the aggregate valid bit of an entry for an address tag of data is stored in a preamble coherence memory 142. In some cases, in addition to the aggregate valid bit, the preamble coherence memory further stores a first portion of the address tag of data stored at one or more of the plurality of local memories (e.g., local caches 120). The prologue coherence memory 144 then stores the rest of the entry for the address tag of data, for example, at least a second portion of the address tag of data stored at the one or more of the plurality of local memories (e.g., local caches 120). Example entries of a preamble coherence memory and a prologue coherence memory where the preamble coherence memory 142 includes the aggregate valid bit and the first portion of the address tag of data are shown in FIGS. 3A and 3B. It should be understood that the tag way halting approach is applicable to a snoop filter with or without the aggregate valid bit and, in some cases, a single bit of the address tag of data (with or without also including the aggregate valid bit) can be stored in the preamble coherence memory (with remaining bits of the address tag of data being stored at the prologue coherence memory).

FIG. 3A illustrates an example entry of a preamble coherence memory of a coherence control circuit; and FIG. 3B illustrates an example entry of a prologue coherence memory of a coherence control circuit.

When included for storing in the preamble coherence memory, the selection of address bits (e.g., “tag bits”) for the preamble coherence memory can be based on the ability of those bits to provide a sufficient filtering capability. For example, the more random/higher the entropy of the values, the more likely the address bits can provide a good filtering capability. In some cases, the least significant bits of a tag can be used. As an illustrative example, four bits of a snoop filter entry are stored at the preamble coherence memory, where three bits are taken from the tag and one bit is the aggregate valid bit. In some cases, the three bits are taken from the tag after applying a hash to the tag. The number of bits from the snoop filter entry may be optimized for any number of factors, resulting in more or fewer bits being stored in the preamble coherence memory. In addition, in some cases, the way halting approach may utilize only tag bits and no aggregate valid bit in the preamble coherence memory for implementations not taking advantage of (or finding the benefit of) the aggregate valid bit.

As noted, for various implementations of a way halting approach described herein, the aggregate valid bit can be stored in the preamble in place of one of the tag bits which would otherwise be there. Although this costs some extra area in the memory of the coherence control circuit (for example in the snoop filter directory RAMs), by including a new aggregate valid bit at the preamble coherence memory, it is possible to find a free way on the first lookup, without having to access all of the prologue coherence memory (e.g., the prologue RAMs), which would impair the power saving value of way halting for allocating accesses to the snoop filter. It can be noted that it may be desirable for the aggregate valid bit to have low entropy (e.g., be more often 0 than 1, which can provide more filtering-especially in the case of numerous shared cachelines). When a system utilizes numerous shared cachelines, a snoop filter can have fewer entries (because each entry covers more cache entries). Similarly, a sectorized snoop filter has higher spatial locality resulting in a greater filtering ability when the aggregate valid bit is more often 0 than 1.

Referring to FIG. 3A, an example entry 300 of a preamble coherence memory includes, in a same row, bits corresponding to eight ways (e.g., way-0 to way-7). A first portion of an address tag of data (e.g., n number of tag bits 302 of way-0) and an aggregate valid bit (e.g., AV bit 304 of way-0) is stored for each way in the row. Referring to FIG. 3B, an example entry 320 of a prologue coherence memory includes, in a row, the second portion of an address tag of data found in the preamble coherence memory. In the example, the second portion of the address tag for way-0 is shown. Here, in addition to the second portion of the address tag 322 (e.g., N-n remaining bits of the Tag bits, where N is the total number of bits of the address tag), the remaining information including secure state 326, entry type 328 (e.g., for region or block), optional sharer identifier/block address 330, and presence bits 332 (e.g., presence/sharers vector or list), as reflected in the example snoop entries of FIGS. 2A and 2B are stored.

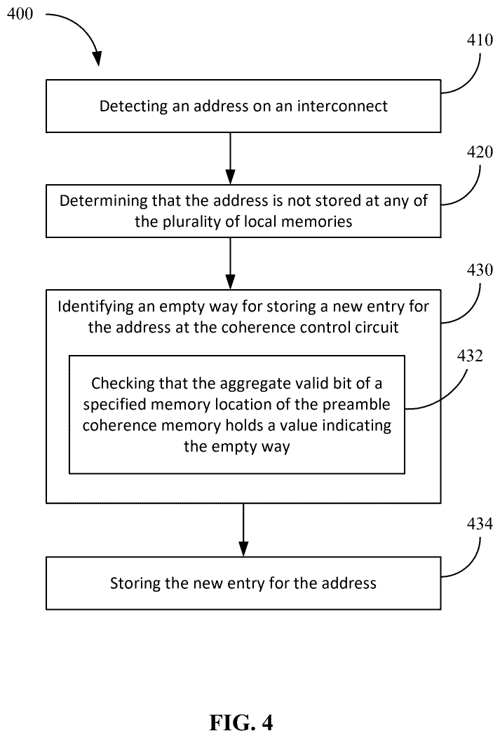

FIG. 4 illustrates an example operation of a coherence control circuit in accordance with certain embodiments described herein. Referring to FIG. 4, a coherence control circuit 140 such as described with respect to FIG. 1 can be structured to perform a method 400 including detecting (410) an address of a memory location; determining (420) that the address is not stored at any of the plurality of local memories; identifying (430) an empty way for storing a new entry for the address at the coherence control circuit from the aggregate valid bit stored at the preamble coherence memory by: checking (432) that the aggregate valid bit of a specified memory location of the preamble coherence memory holds a value indicating the empty way; and storing (434) the new entry for the address.

The detected address of a memory location can be detected on an interconnect coupled to the plurality of local memories (e.g., local caches 120). Each local memory of the plurality of local memories provide a possible location of a copy of data from the memory location. In some cases, detecting (410) an address on the interconnect involves monitoring transactions from the processing units (e.g., processing units 110). In some cases, the coherence control circuit 140 detects an address on the interconnect as a result of an allocation transaction or deallocation/eviction transaction carried out with respect to one of the local memories. For stored addresses, the detection of the address on the interconnect can be used to update presence bits at the prologue coherence memory as well as the aggregate valid bit. Indeed, in some cases, the aggregate valid bit can be updated based on information from each of the plurality of local memories indicating whether the address is stored at that local memory. The aggregate valid bit may not actually be changed until all local memories indicate that they do not store the address. Here, the information from each of the plurality of local memories can be represented by the presence bits stored at the prologue coherence memory as a result of monitoring the transactions (e.g., allocation or deallocation/eviction). Accordingly, in some cases, the coherence control circuit 140 can be structured to perform an OR operation of the information from each of the plurality of local memories indicating whether the address is stored at that local memory; and update the aggregate valid bit to a logical 0 when a result of the OR operation is a logical 0. Alternatively, the aggregate valid bit can be cleared as a result of a different operation than the OR operation, for example, at an initialization to empty or when the last presence bit is to be deleted.

In some cases, determining (420) that the address is not stored at any of the plurality of local memories includes: performing a lookup operation at the preamble coherence memory; and determining that there is not a valid aggregate valid bit. In some of such cases, the lookup is continued in the prologue memories to confirm the miss.

In some cases, determining (420) that the address is not stored at any of the plurality of local memories includes: performing a lookup operation for a first portion of a tag for the address at the preamble coherence memory; and determining a miss of the first portion of the tag for the address at the preamble coherence memory. In such a case, a miss can be identified by only a lookup of the preamble coherence memory (although it is also possible to continue the lookup in the prologue memories to confirm the miss).

In some cases determining (420) that the address is not stored at any of the plurality of local memories includes: performing a lookup operation for a first portion of a tag for the address at the preamble coherence memory; determining a partial hit of the first portion of the tag for the address at the preamble coherence memory; performing a lookup operation for a second portion of the tag for the address at the prologue coherence memory based on the partial hit of the first portion of the tag for the address at the preamble coherence memory; and determining a miss of the second portion of the tag for the address at the prologue coherence memory.

As indicated above, identifying (430) an empty way for storing a new entry for the address at the coherence control circuit can be performed by: checking (432) that the aggregate valid bit of a specified memory location of the preamble coherence memory holds a value indicating the empty way. The checking (432) can be accomplished using a read operation and logic internal or external to the memory. The specified memory location can be selected in any suitable manner including random, in parallel, sequential, consecutive, or based on location of last miss, as some examples. In this manner, it is possible to identify an empty way by simply checking the aggregate valid bit. In some cases, identifying (430) an empty way further includes determining a miss from the bits corresponding to a first portion of the possible address tag.

In some cases, storing (434) the new entry for the address includes storing a first portion of an address tag for the address with a valid value for the aggregate valid bit. The valid value for the aggregate valid bit can be a logical 1 while the value indicating the empty way is a logical 0. The second portion of the address tag is stored in a prologue coherence memory corresponding to the empty way.

As an illustrative example for a coherence control circuit in the form of a snoop filter, the snoop filter can receive opcode indicating to “read, if miss allocate;” the snoop filter can read the preamble memory (and prologue coherence memory) to find a matched entry. If there is a matched entry the snoop filter returns a hit response; if there is a miss (e.g., because no matched entry), the snoop filter allocates the cacheline in an empty way that is available and pointed by preamble memory. However, if there is no empty way, the snoop filter can evict a suitable way and allocate the new entry at the evicted position.

The next time the coherence control circuit detects the address for a memory location, the coherence control circuit can determine that the address is stored at one or more of the plurality of local memories by: performing a lookup operation at the preamble coherence memory; and when a first portion of a tag for the address is also stored at the preamble coherence memory, determining a partial hit of the first portion of the tag for the address at the preamble coherence memory. After performing the lookup operation at the preamble coherence memory, the coherence control circuit further performs a lookup operation for the tag for the address at the prologue coherence memory (e.g., a second portion of the tag, which can be based on the partial hit of the first portion of the tag for the address at the preamble coherence memory); and determining a hit of the tag for the address at the prologue coherence memory based at least on the aggregate valid bit stored at the preamble coherence memory being valid.

During operation, when an address of a memory location is detected, a coherence control circuit can stall any operations to the same cacheline address until an update to the coherence memory is complete (e.g., for storing a new entry or making an adjustment to presence bits, etc.).

FIG. 5 illustrates an example coherence control circuit. Referring to FIG. 5, circuit 500 includes an arbiter 502, preamble coherence memory 504, register (d-type flop) 506, logic 508, prologue coherence memory 510, hit/miss calculation circuit 512, and RAM update queue 514. An input transaction 520 (e.g., from interconnect 130 of FIG. 1) and a ram update request 522 from the RAM update queue 514 can be received at the arbiter 502.

To find whether a memory address is in the memory of the coherence control circuit, a lookup operation is performed. As part of the lookup operation, a portion of an incoming address (e.g., the portion providing the tag function) is compared to the stored tags in the tag RAMs. A “hit” occurs when the incoming address (e.g., the portion providing the tag function) matches a stored tag in a way and the stored tag is considered valid (e.g., as per appropriate state bits(s)).

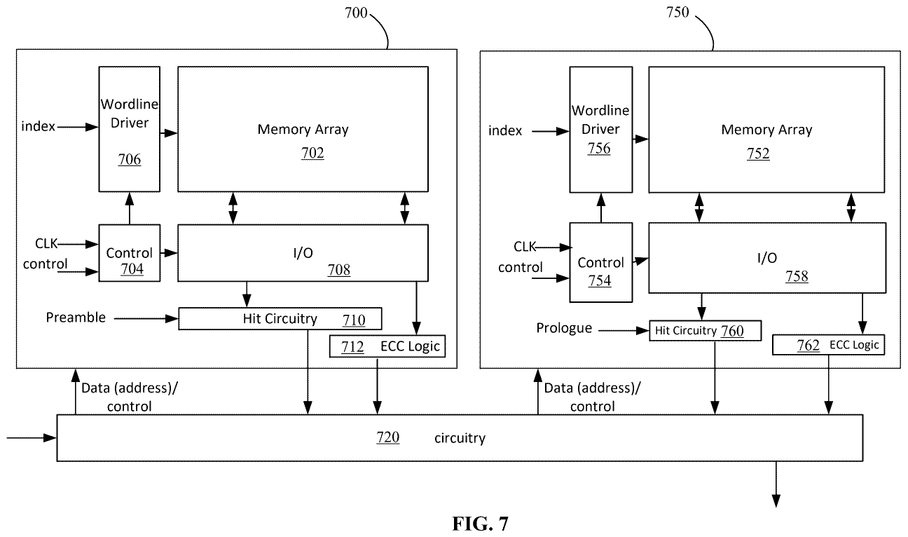

To this end, when an input transaction 520 is received, the appropriate data is output the arbiter providing read/write control (and the address/index) to the preamble coherence memory 504. The read/write control is used by the preamble coherence memory 504 to determine which way (e.g., way_en [7:0]) at the prologue coherence memory 510 to access. The data output the arbiter is also stored at the register 506 for combining at the logic 508 with the output of the preamble coherence memory 504 so as to provide the read/write control and address (index) for the prologue coherence memory 510. The output of the arbiter can be the incoming transaction or the transaction needed to make an update (from the update queue), depending on the arbiter select. The output can include RAM address (index), whether the operation is a read or a write, and what to update (e.g., aggregate valid bit, presence bits, coherence state, etc.). In some cases, logic 508 includes an AND gate. The data stored at the register 506 and the output of the prologue coherence memory 510 are used by the hit/miss calculation circuit 512 to determine whether there is a hit or miss. The output of the hit/miss calculation circuit 512 is provided to the coherence control circuitry (e.g., snoop control circuitry) to decide whether and where to send requests, including the RAM update queue 514 for use as part of the RAM update request. While the hit/miss calculation logic is shown in its own block in the figure, in some cases, such as shown in FIG. 7, at least some of the hit/miss calculation logic can be inside the RAM instances (along with an ECC check).

In operation, preamble coherence memory 504 is read out before reading from the prologue coherence memory 510. Preamble data indicates which ways of the prologue coherence memory 510 are empty (if aggregate valid is 0) or none. A read operation is performed only for those ways in the prologue coherence memory 510 which has partial hit in preamble coherence memory 504. If there is a miss, it is possible to allocate the new address to an empty way indicated by the preamble coherence memory 504. The aggregate valid bit stored at the preamble coherence memory 504 reflects which way is empty and this information is passed along the transaction and used for allocation. In some cases, if there is no miss, a back invalidation can be performed so as to evict and replace a way. The eviction can be based on any suitable eviction policy.

FIG. 6 is a block diagram of an example implementation of data processing system 100 of FIG. 1. Referring to FIG. 6, data processing system 600 is an SoC that includes a number of functional blocks connected together by interconnect circuit 605. The functional blocks include processing blocks 610, each including a cluster of processing cores 612 that share an L2 cache 614, with each processing core (e.g., central process unit (CPU)) having its own L1 cache 616. Other processing devices, such as, but not limited to, a graphics processing unit (GPU), a digital signal processor (DSP), a field programmable gate array (FPGA) an application specific integrated circuit (ASIC) device, or an artificial intelligence engine, may be used.

Processing blocks 610 can be request nodes that generate requests for data transactions, such as ‘load’ and ‘store’, for example. The request nodes are end points for such transactions. Processing blocks 610 can be coupled to data resources, including shared memory 620 (e.g., L3 cache or a lowest/last level cache) and main memory 630 (access through memory controller 635), via the interconnect circuit 605. Main memory 630 may be on the chip or external to the chip. The shared memory 620 can be part of a device considered as a home node, which serves as a home for blocks of data associated with sets of data addresses. The home nodes respond to data transactions from request nodes and, in responding, may perform data transactions with other functional blocks, such as a memory controller or an I/O device.

To maintain coherence between memory resources, each processing block 610 includes a cache controller 618 that accepts load and store instructions from the processor cores 612. The cache controller 618 also issues and receives coherence requests and responses via the interconnect circuit 615 from other nodes. In some cases, it is possible to incorporate features of coherence control circuit 140 in the cache controller 618.

In addition, to avoid excessive exchange of messages between the cache controllers 618 of the processing blocks 610, a cache coherency circuit in the form of a snoop filter 640 can be included. Snoop filter 640 monitors data transactions and operates to maintain coherency of data in the various caches of the system.

The block, or home node acts as a point of coherence in that the home node issues coherence responses and receives coherence requests via the interconnect circuit 605 from other nodes. A home node is an intermediate node: it responds to data transaction requests from a request node, and can issue data transaction requests to other devices such as a memory controller. Thus, a home node may act as an intermediary node between a request node and a memory, and may include a cache for temporary storage of data. The snoop filter 640 of a home node provides a point of coherence. Since memory accesses, for a given set of memory addresses in shared data resource, pass through the same home node, the home node can monitor or ‘snoop’ on transactions and determine if requested data should be retrieved from a main memory, from a cache in the home node, or from a local cache of one of the request nodes. Snoop filter 640 can be implemented as described with respect to coherence control circuit 140.

FIG. 7 illustrates an example coherence preamble and prologue coherence memory that can be used as part of a coherence control circuit. Referring to FIG. 7, an n-way memory subsystem of a coherence control circuit such as a snoop filter can include operational circuitry 720, one or more preamble coherence memory 700 and one or more prologue coherence memories 750 for each preamble coherence memory 700. In addition, in various implementations, more than one way may be combined in a same prologue coherence memory. For example, two or more ways may be combined into one RAM. Further, in some cases, more than one preamble coherence memory is provided in order to be able to store the preambles of all the ways. Indeed, in some cases, the snoop filter or other memory subsystem includes multiple preamble coherence memories and corresponding one or more prologue coherence memories.

Operational circuitry 720 supports various functionality of the coherence control circuit, including, but not limited to, logic and timing. An example of operational circuitry 720 is shown in FIG. 5 with arbiter 502, register 506, logic 508, hit/miss calculation circuit 512, and RAM update queue 514. Of course, more or fewer elements can be included as part of operational circuitry. In addition, some and/or part of the elements can be part of the control circuit of the memory that is used for reading to and writing from the memory of the coherence control circuit.

The preamble coherence memory 700 stores preamble bits of tags. An example of the data stored in the preamble coherence memory is shown in FIG. 3A. The one or more prologue coherence memories 750 store prologue bits of the tags corresponding to a second set of bits of the tags stored in the preamble coherence memory 700. An example of the data stored in a prologue coherence memory is shown in FIG. 3B. A two-phase access is enabled by using the preamble coherence memory 700 to control access to the one or more prologue coherence memories 750. That is, access to the one or more prologue coherence memories 750 is based on a partial hit of a received address on preamble bits stored in the preamble coherence memory 700.

Preamble coherence memory 700 includes a memory array 702, a control circuit 704, wordline driver 706, input/output circuitry 708, hit circuitry 710, and, in some cases, part of an error correction code circuitry (ECC logic 712).

The memory array 702 is structured in an array of bitcells with rows accessed by wordlines and columns accessed by bitlines. Each bitcell refers to the memory element storing a single bit of information. In certain implementations, memory array 702 is SRAM. The control circuit 704 provides control signals for operations of the preamble coherence memory 700. The wordline driver 706 receives an address (e.g., the index bits) and turns on a wordline indicated by the index bits in response to receiving a signal from the control circuit 704. The input/output circuitry 708 contains the read circuitry and write circuitry that utilize bitlines to read and write data out of and into the memory array 702. The hit circuitry 710 supports the determination of a hit/miss of the tag bits within the preamble coherence memory 700 and the ECC logic 712 supports certain parts of error correction processes (for a partial ECC operation) within the preamble coherence memory 700.

Prologue coherence memory 750 includes a memory array 752, a control circuit 754, wordline driver 756, input/output circuitry 758, hit circuitry 760, and, in some cases, part of an error correction code circuitry (ECC logic 762).

Memory array 752, control circuit 754, wordline driver 756, and input/output circuitry 758 can be implemented such as described with respect to memory array 702, control circuit 704, wordline driver 706, and input/output circuitry 708. The hit circuitry 760 supports the determination of a hit/miss of the tag bits for a way. Since the prologue coherence memory 750 is intended to read out one way at a time, fewer columns of the memory array 752 may be coupled to hit circuitry 760 as compared to the preamble coherence memory 700. However, implementations may vary. ECC logic 762 supports certain parts of error correction processes within the prologue coherence memory 750.

As is apparent from the example of FIG. 7, it is possible to use various memory configurations for the preamble coherence memory and the prologue coherence memory. For example, by including a fast comparator inside the RAM instance of the preamble coherence memory, it is possible to perform the tag compare in roughly the same time as a read and ECC check logic. As described above, a matching operation can be performed on the bits in the preamble coherence memory, for all the ways contained in the preamble RAM. This enables just 1 bit per way to be output from the preamble RAM, rather than all of the tag bits. Similarly, when ECC check logic is included, the ECC check (but not necessarily the correct logic) can be performed and only the result of this check (such as the ‘syndrome’ bits) is output for all of the contents of the preamble RAM. These two techniques together reduce the number of bits that are output from the RAM instance and the corresponding energy requires to drive them out and to compute the match and ECC check.

The result of the hit (and ECC) logic inside the RAM is a reduction in the pipeline length. Because the preamble RAMs are relatively small, it is possible to place the preamble RAMs physically closer to the coherency logic, which contributes to keeping the pipeline length low, and saving power, by reducing the number of long wires being commonly accessed.

As shown in the example of FIG. 7, while not required, it is also possible to include the error checking and hit comparison logic inside the prologue coherence memory instances.

Accordingly, it is possible to implement the preamble coherence memory and/or the prologue coherence memory using standard SRAMs and external hit and ECC logic.

In various embodiments, the described apparatus and circuitry, including the described coherence control circuits, may be defined by instructions of a Hardware Description Language, which can be stored on a computer-readable storage medium. It should be understood that, as used herein, a storage medium does not consist of propagating signals.

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims and other equivalent features and acts are intended to be within the scope of the claims.

What is claimed is:

1. An apparatus comprising:
a coherence control circuit for managing coherency of a plurality of local memories, the coherence control circuit comprising:
a preamble coherence memory; and
a prologue coherence memory,
wherein the preamble coherence memory stores at least one bit associated with an address tag of data stored at one or more of the plurality of local memories; and wherein the prologue coherence memory stores at least a portion of the address tag of data stored at the one or more of the plurality of local memories,
wherein access to the prologue coherence memory is based on a partial hit of a received address on the at least one bit stored in the preamble coherence memory.

2. The apparatus of claim 1, wherein the at least one bit is a single bit of the address tag of data.

3. The apparatus of claim 1, wherein the at least one bit comprises an aggregate valid bit.

4. The apparatus of claim 3, wherein the at least one bit further comprises a single bit of the address tag of data.

5. The apparatus of claim 3, wherein the coherence control circuit is structured to identify an empty way for storing a new entry for an address of a memory location at the coherence control circuit using the preamble coherence memory by:
checking that the aggregate valid bit of a specified memory location of the preamble coherence memory holds a value indicating the empty way.

6. The apparatus of claim 3, wherein the at least one bit further comprises a first portion of the address tag of data, wherein the portion stored at the prologue coherence memory is a remaining portion of the address tag of data.

7. The apparatus of claim 1, wherein the at least one bit comprises a first portion of the address tag of data, wherein the portion stored at the prologue coherence memory is a remaining portion of the address tag of data.

8. The apparatus of claim 1, further comprising: the plurality of local memories, each local memory of the plurality of local memories providing a possible location of a copy of data.

9. The apparatus of claim 1, wherein the coherence control circuit comprises a snoop filter.

10. The apparatus of claim 9, wherein the preamble coherence memory and the prologue coherence memory of the snoop filter each include hit circuitry.

11. The apparatus of claim 10, wherein the preamble coherence memory and the prologue coherence memory of the snoop filter each further include error correction code (ECC) logic for a partial ECC operation.

12. A method comprising:
detecting, by a coherence control circuit, an address of a memory location, wherein each local memory of a plurality of local memories provide a possible location of a copy of data from the memory location, wherein the coherence control circuit comprises a preamble coherence memory and a prologue coherence memory, wherein the preamble coherence memory stores an aggregate valid bit; and wherein the prologue coherence memory stores at least a portion of an address tag of data stored at the one or more of the plurality of local memories;
determining, by the coherence control circuit, that the address is not stored at any of the plurality of local memories; and
identifying, by the coherence control circuit, an empty way for storing a new entry for the address at the coherence control circuit from the aggregate valid bit stored at the preamble coherence memory.

13. The method of claim 12, wherein storing the new entry for the address comprises storing a valid value for the aggregate valid bit.

14. The method of claim 12, wherein the preamble coherence memory further stores a first portion of the address tag of data stored at the one or more of the plurality of local memories, wherein identifying, by the coherence control circuit, the empty way for storing the new entry for the address at the coherence control circuit further includes determining a miss from bits corresponding to a first portion of a possible address tag.

15. The method of claim 12, wherein the preamble coherence memory further stores a first portion of the address tag of data stored at the one or more of the plurality of local memories, wherein determining, by the coherence control circuit, that the address is not stored at any of the plurality of local memories comprises:
performing a lookup operation for a first portion of a tag for the address at the preamble coherence memory; and
determining a miss of the first portion of the tag for the address at the preamble coherence memory.

16. The method of claim 12, wherein determining, by the coherence control circuit, that the address is not stored at any of the plurality of local memories comprises:
performing a lookup operation at the preamble coherence memory; and
determining that there is not a valid aggregate valid bit.

17. The method of claim 12, wherein the preamble coherence memory further stores a first portion of the address tag of data stored at the one or more of the plurality of local memories, wherein determining, by the coherence control circuit, that the address is not stored at any of the plurality of local memories comprises:
performing a lookup operation for a first portion of a tag for the address at the preamble coherence memory;
determining a partial hit of the first portion of the tag for the address at the preamble coherence memory;
performing a lookup operation for a second portion of the tag for the address at the prologue coherence memory based on the partial hit of the first portion of the tag for the address at the preamble coherence memory; and
determining a miss of the second portion of the tag for the address at the prologue coherence memory.

18. The method of claim 12, further comprising updating the aggregate valid bit based on an indication from each of the plurality of local memories indicating whether the address is stored at that local memory.

19. The method of claim 12, further comprising:
detecting, by the coherence control circuit, the address of the memory location; and
determining, by the coherence control circuit, that the address is stored at one or more of the plurality of local memories by at least checking that the aggregate valid bit stored for the address at the preamble coherence memory has a valid value for the aggregate valid bit.

20. The method of claim 12, wherein the coherence control circuit comprises a snoop filter.
